(19) United States
(12) Patent Application Publication
(10) Pub. No.: US 2008/0189292 A1
(43) Pub. Date: Aug. 7, 2008

(54) System and method for automatic population of a contact file with contact content and expression content

(76) Inventors: Jed Stremel, Palo Alto, CA (US); TS Ramakrishnan, Palo Alto, CA (US); Mark Slee, Palo Alto, CA (US)

Correspondence Address: CARR & FERRELL LLP, 2200 GENG ROAD, PALO ALTO, CA, 94303, US

(21) Appl. No.: 11/701,566

(22) Filed: Feb. 2, 2007

(51) Int. Cl. G06F 17/30

(52) U.S. Cl. 707/10; 707/E17.032

(57) ABSTRACT

A system and method for automatically populating a contact file with contact content and expression content are provided. An identifier is received on a device that is used to query a server in communication with a web-based social network database. According to one embodiment, contact content automatically populates a contact file on the device with contact content from the web-based social network database, including expression content. When the contact content on the web-based social network database changes, the contact file on the device is automatically updated with the updated contact content. As a result, the need to manually populate contact files by using a keyboard or similar data entry device is avoided. Additionally, typographical errors are reduced or eliminated by automatically populating the contact file. A further exemplary system includes the device receiving an identifier in the form of caller identification or caller ID from a second device, which may be used to trigger the display of contact content from the contact file and/or the requesting of contact content by the contact content request module.

### CROSS-REFERENCE TO RELATED APPLICATIONS

The present application incorporates by reference:

U.S. patent application Ser. No. 11/639,655 filed on Dec. 14, 2006 for “Systems and Methods for Social Mapping,” which in turn claims the benefit and priority of U.S. Provisional Patent Application Ser. No. 60/750,844 filed on Dec. 14, 2005 for “Systems and Methods for Social Mapping,”

U.S. patent application Ser. No. 11/646,206 filed on Dec. 26, 2006 for “Systems and Methods for Social Timeline,” which in turns claims the benefit and priority of U.S. Provisional Patent Application Ser. No. 60/753,810 filed on Dec. 23, 2005 for “Systems and Methods for Social Timeline,”

U.S. patent application Ser. No. 11/493,291 filed on Jul. 25, 2006 for “Systems and Methods for Dynamically Generating a Privacy Summary,”

U.S. patent application Ser. No. 11/499,093 filed on Aug. 2, 2006 for “Systems and Methods for Dynamically Generating Segmented Community Flyers,”

U.S. patent application Ser. No. 11/502,757 filed on Aug. 11, 2006 for “Systems and Methods for Generating Dynamic Relationship-Based Content Personalized for Members of a Web-Based Social Network,”

U.S. patent application Ser. No. 11/503,093 filed on Aug. 11, 2006 for “Systems and Methods for Measuring User Affinity in a Social Network Environment,”

U.S. patent application Ser. No. 11/503,037 filed on Aug. 11, 2006 for “Systems and Methods for Providing Dynamically Selected Media Content to a User of an Electronic Device in a Social Network Environment,”

U.S. patent application Ser. No. 11/503,242 filed on Aug. 11, 2006 for “System and Method for Dynamically Providing a News Feed About a User of a Social Network,”

U.S. patent application Ser. No. 11/580,210 filed on Oct. 11, 2006, for “System and Method for Tagging Digital Media,”

U.S. Provisional Patent Application Ser. No. 60/856,416 filed on Nov. 3, 2006 for “Systems and Methods for a Web-Based Social Networking Environment Integrated Within One or More Computing and/or Networking Applications,”

U.S. Provisional Patent Application Ser. No. ______ filed on Feb. 2, 2007, Attorney Docket No. PA4074PRV entitled “System and Method for Automatically Giving Gifts and Displaying Assets in a Social Network Environment,”

U.S. patent application Ser. No. ______ filed on Feb. 2, 2007, Attorney Docket No. PA3700US entitled “System and Method for Digital File Distribution,”

U.S. patent application Ser. No. ______ filed on Feb. 2, 2007, Attorney Docket No. PA4029US entitled “System and Method for Determining a Trust Level in a Social Network Environment,” and

U.S. patent application Ser. No. ______ filed on Feb. 2, 2007, Attorney Docket No. PA4032US entitled “System and Method for Curtailing Objectionable Behavior in a Web-Based Social Network.”

### BACKGROUND OF THE INVENTION

1. Field of the Invention

The present invention relates generally to electronic contact files, and more particularly to systems and methods for automatically populating an electronic contact file with contact content and expression content.

2. Description of Related Art

Conventionally, users of electronic contact files populate the files by using a keyboard to manually enter the relevant information. This is a very time consuming process, compounded by people moving frequently between jobs and/or physical locations, resulting in the user having to frequently manually update the contact files. In some cases, items such as business cards containing contact information are lost before the information is entered in a contact file. Further, manually entered contact information often contains typographical errors.

When people do share contact information, they often wish to share varying amounts of information about themselves, depending on the party requesting the information. Some people are understandably hesitant to share personal information such as their home address or telephone number. In contrast, close friends and relatives often wish to share additional information, such as audiovisual information. Contact files, however, are often incapable of containing and/or storing audiovisual information. Additionally, it is very burdensome if not impossible to manually program a contact file to contain information in a variety of formats, such as audio, photographic, video, audiovisual and/or text that may be dynamically updated. There is thus a need for a system and method for automatic population of a contact file with contact content and expression content.

### SUMMARY OF THE INVENTION

Systems and methods are provided for automatically populating contact files with contact content and expression content. An exemplary method according to one embodiment includes receiving a request for contact content, querying a web-based social network database for the contact content, and providing the contact content to a communications module for transmitting to a device. Another exemplary method includes receiving on a device an identifier associated with contact content, sending the identifier to a server, receiving the contact content from the server and storing the contact content in a contact file on the device. A further exemplary method includes receiving on a first device an identifier sent from a second device, which may also be used to trigger display of contact content from a contact file or request the associated contact content from a server.

An exemplary system according to one embodiment comprises a server configured with a web-based social network database and a server contact application. The server contact application is configured with a query module configured to query the web-based social network database for contact content, a device specification and optimization module configured to optimize the contact content to accommodate specifications of a device, a device user settings module configured to store user settings for the device, and a contact privacy settings module configured to limit the querying of the web-based social network database or the contact content sent from the server.

In another exemplary system, a device contact application comprises a contact content request module configured to receive an identifier and request contact content, and a contact file configured to receive and store the contact content. A further exemplary system includes a device configured to receive an identifier in the form of caller identification or caller ID from a second device, which may be used to trigger the display of associated contact content from a server.

### BRIEF DESCRIPTION OF THE DRAWINGS

FIG. 1 illustrates and exemplary architecture for automatically populating a contact file with content and expression content;

FIG. 2 shows a screenshot for an exemplary contact content request screen used to request contact content from a web-based social network database;

FIG. 3 shows a screenshot of an exemplary web-based social network database record;

FIG. 4 shows a screenshot of an exemplary contact content screen; and

FIG. 5 shows a flow chart for an exemplary method for automatically populating a contact file on a device with contact content from a server.

### DETAILED DESCRIPTION OF THE INVENTION

A system and method for automatically populating a contact file with contact content and expression content are provided. An identifier is received on a device that is used to query a web-based social network database. According to one embodiment, contact content automatically populates a contact file on the device with contact content from the web-based social network database, including expression content. When the contact content on the web-based social network database changes, the contact file on the device is automatically updated with some or all of the changed or updated contact content. As a result, the need to manually populate contact files by using a keyboard or a similar data entry device is avoided. Additionally, typographical errors are reduced or eliminated by automatically populating the contact file. A further exemplary system includes a device configured to receive an identifier in the form of caller identification or caller ID from a second device, which may be used to trigger the display of contact content from the contact file on the device and/or the requesting of contact content associated with the identifier from a server.

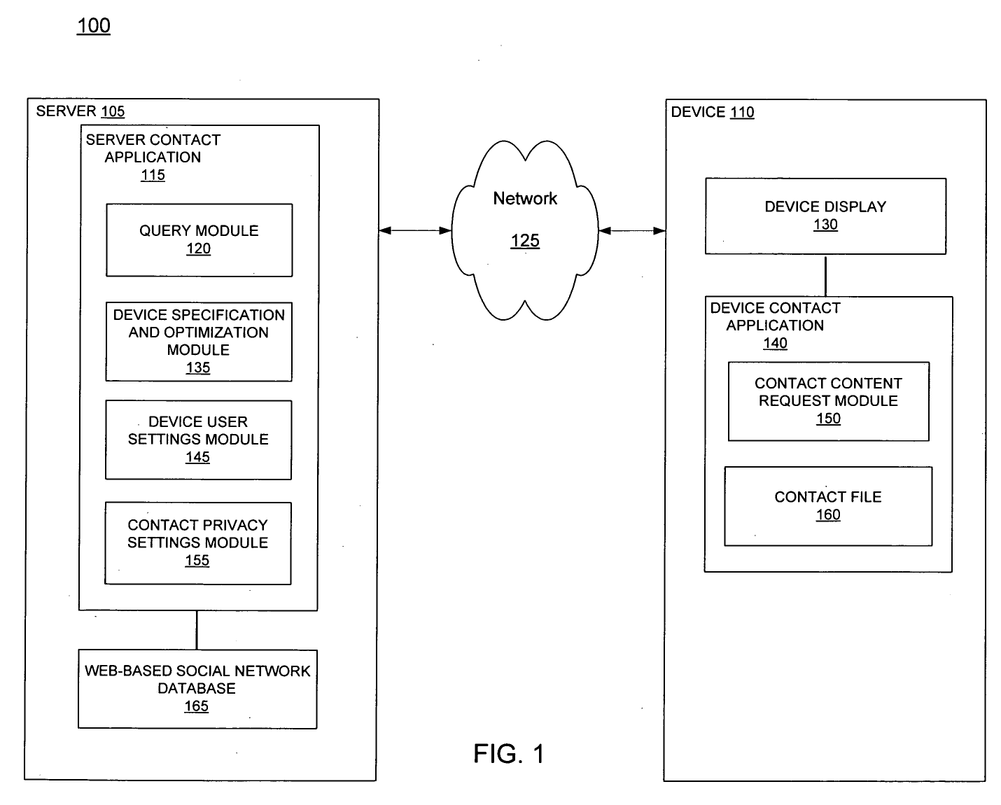

FIG. 1 illustrates an exemplary architecture 100 for automatically populating a contact file with contact content. Architecture 100 comprises a server 105, a network 125, and a device 110. Server 105 comprises a server contact application 115 and a web-based social network database 165. Server contact application 115 comprises a query module 120, a device specification and optimization module 135, a device user settings module 145, and a contact privacy settings module 155. Device 110 comprises device display 130, and a contact application 140, which further comprises a contact content request module 150, and a contact file 160.

According to one embodiment, an identifier corresponding to a contact in web-based social network database 165 is received on the device 110. The identifier may be received due to manual entry by a user of the device 110 or the identifier may be received from another device in the form of caller identification or caller ID. If the received identifier has associated contact content in contact file 160, the associated contact content will be retrieved and displayed on device display 130. If an identifier received on device 110 is not associated with contact content in contact file 160, a contact content request module 150 uses the identifier to request associated contact content from server 105.

In addition to receiving and storing contact content received from web-based social network database 165, contact file 160 can store information manually entered by a user on device 110. For example, before joining a web-based social networking service having a web-based social network database, such as web-based social network database 165, a device user may have manually entered information into a previously existing contact file that was provided with the device at the time the device was sold to the user. After joining a web-based social networking service, the device 110 may utilize information in the device's previously existing contact file to query web-based social network database 165 for additional or updated contact content associated with identifiers in the device's previously existing contact file. Additional or updated contact content may comprise contact content recently added or revised by a contact in the web-based social network database 165.

If an identifier received on device 110 is not associated with contact content in contact file 160, a contact content request module 150 uses the identifier to request associated contact content from server 105. For example, the contact content request module 150 can use the identifier of “John Smith” or the identifier of “jsmit” to request contact content from server 105 corresponding to John Smith. According to one embodiment, server 105 comprises a web-based social network database 165. Social network database 165 is a database of any entity that provides web-based social networking services, communication services and/or dating services. Identifiers sent to server 105 can include such alphanumeric characters as a first name, a middle name, a last name, email address, phone number, or any other alphanumeric character or characters or combination likely to uniquely correspond to a particular contact in the web-based social network database 165.

Turning to server 105, the server contact application 115 comprises a query module 120 responsible for querying the web-based social network database 165 for contact content. The query module 120 also queries the web-based social network database 165 for updated contact content. Contact content associated with the identifier is sent from server 105 to device 110. Device 110 includes such devices as a mobile phone, personal digital assistant (“PDA”), desktop computer, and/or laptop computer. Contact content is stored in contact file 160. Contact content stored in contact file 160 can be displayed on device display 130. In further embodiments, device display 130 may function as a touch screen in addition to being used for viewing contact content.

According to various embodiments, contact content includes expression content, such as audio/video. Audio/video is any audio, video, audiovisual, pictorial, photograph, image form, text file, and/or all variations and combinations thereof. Information in the web-based social network database 165 may include information from a social map and/or a social timeline. A social map can be a display of the interactions, relationships and experiences of individuals or groups of individuals comprising the web-based social network database 165. A social timeline in one embodiment is a chronological listing of a user selected subset of individuals comprising the web-based social network database 165 in categories such as coworkers, classmates, travel companions, hookups, classmates, summer/abroad friends, relationships and/or teammates.

According to some embodiments, a contact privacy settings module 155 forms part of web-based social network database 165. In alternative embodiments, contact privacy settings module 155 forms part of server contact application 115. Contact privacy settings module 155 stores contact privacy settings for contacts in web-based social network database 165. In one embodiment, a particular contact in the web-based social network database 165 can select privacy settings to provide contact content to only those people designated by that contact as “friends” of the contact. Accordingly, contact privacy settings module 155 may limit the contact content that a user of the device 110 can query and/or access about a particular contact in the web-based social network database 165. Alternatively, the privacy settings module 155 may allow querying and/or accessing of contact content about a particular contact, however, will limit the contact content that is sent from the server 105 to the device 110.

The server contact application 115 may comprise a device user settings module 145 for controlling such functions as when the server 105 communicates with the device 110. For example, the device user settings module 145 can be set to direct the server 105 to communicate with the device 110 during standard working hours. The device user settings module 145 can also be set to allow the server 105 to communicate contact content to the device 110 in response to certain changes in the web-based social network database 165. For example, the device user settings module 145 can be set to allow the server 105 to communicate contact content to the device 110 when a particular contact in the web-based social network database 165 updates her class schedule, telephone number, email address or expression content in the web-based social network database 165.

A device specification and optimization module 135 on the server contact application 115 may be configured with the specifications for a wide variety of devices 110 communicating with the server 105. The device specification and optimization module 135 recognizes the type of device 110 being used to communicate with the server 105 and formats contact content to accommodate the specifications of the particular device 110. For example, the device specification and optimization module 135 can automatically recognize that a particular user is communicating with the server 105 with a BlackBerry™ device and will format contact content to accommodate the device display 130 of the BlackBerry™ device.

The server 105 communicates with the device 110 across one or more networks 125. The device 110 may also communicate with other devices similar to device 110. The network 125 may include an Internet network and/or other wireless or wired networks such as mobile device carrier networks. A number of commonly known communications mechanisms can be used for the server 105 to communicate with the device 110 across the network 125.

It will readily be appreciated by one of ordinary skill in the art that web-based social network database 165 may also function as a standalone application, separate from server contact application 115. There are multiple possible combinations and locations for the herein described component applications and modules. A number of commonly known communications mechanisms can be used for device 110 to communicate with the server 105 across network 125. Network 125 may include an Internet network and/or other wireless or wired networks such as mobile device carrier networks. Further, device 110 may also directly communicate with other devices similar to device 110. All of these variations remain within the scope of claimed embodiments.

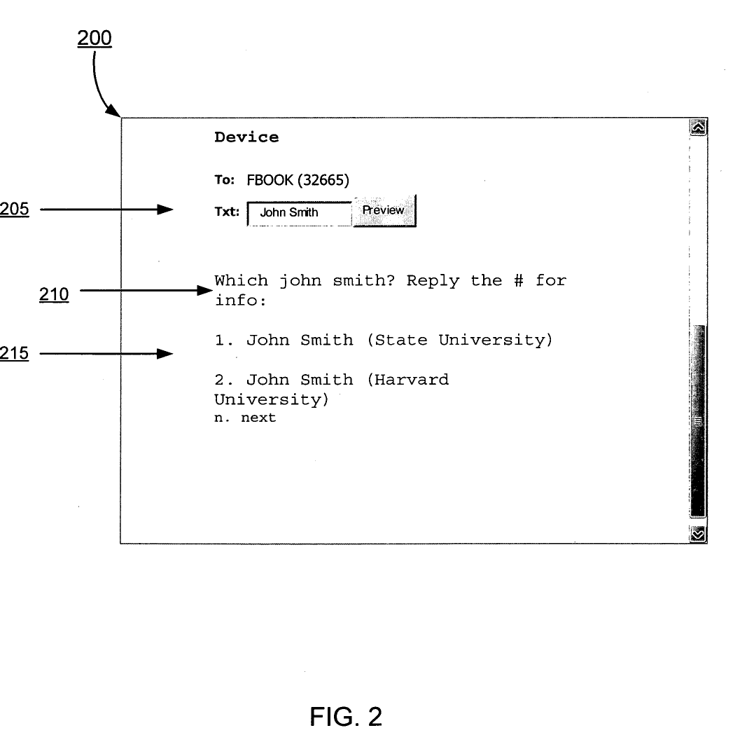

FIG. 2 shows an exemplary screenshot for a contact content request screen 200 on device 110 (FIG. 1). The contact content request screen 200 is used to request contact content from the server 105 (FIG. 1). The contact content request screen 200 includes an identifier entry box 205, selection choices 215 and user instructions 210. The contact content request screen 200 typically appears on device display 130 (FIG. 1).

An identifier corresponding to a contact in the web-based social network database 165 (FIG. 1) is received in identifier entry box 205. The identifier may be received due to manual entry by a user of device 110 or the identifier may be received from another device. In the exemplary contact content request screen 200, the identifier “John Smith” is received in the identifier entry box 205.

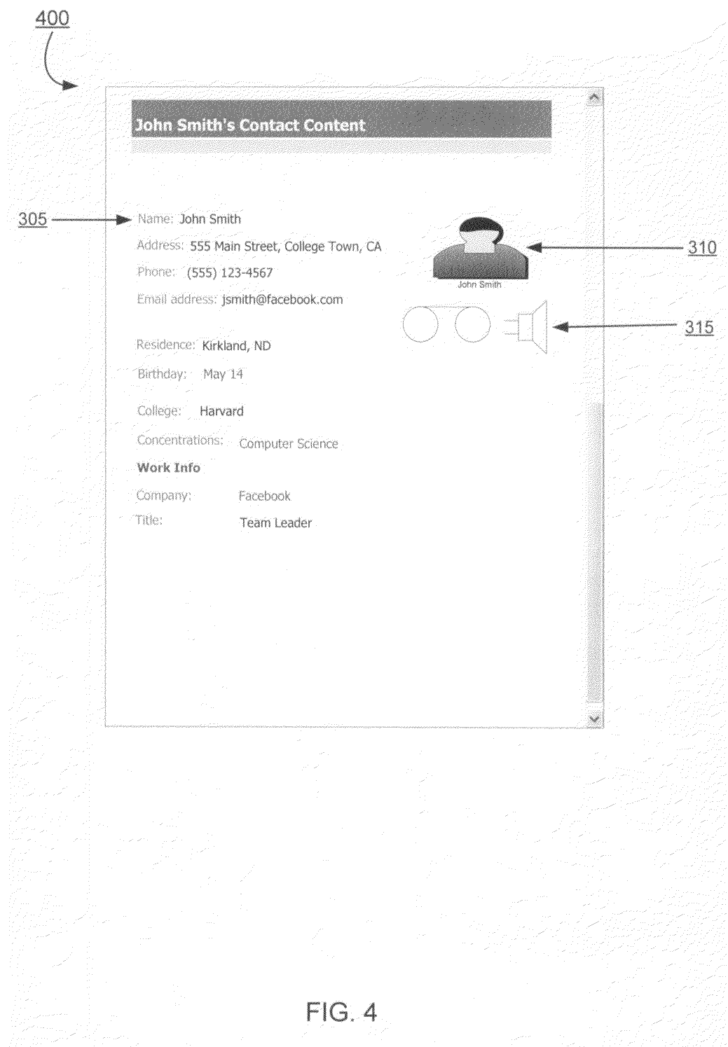

In one embodiment, the device 110 queries the contact file 160 (FIG. 1) for the contact content associated with the identifier. If the contact content associated with the identifier is located in the contact file 160, contact content may be displayed on the device display 130 (FIG. 1) in a form that is the same as or similar to the contact content screen 400 described in connection with FIG. 4.

If the contact content associated with the identifier is not located in the contact file 160, device 110 will send a query to server 105 (FIG. 1). In response, query module 120 (FIG. 1) on server 105 queries the web-based social network database 165 for the contact content associated with the identifier “John Smith.” As a result of the query, selection choices 215 are communicated from the server 105 to the device 110 and displayed on the contact content request screen 200. Alternatively, depending on the identifier received, selection choices 215 might be skipped in lieu of going directly to the contact content screen such as the contact content screen 400 described in connection with FIG. 4. For example, the identifier received might be associated with contact content for only one contact in the web-based social network database 165.

The selection choices 215 shown in FIG. 2 include two possible choices for contact content corresponding to “John Smith.” The first choice is for John Smith of State University. The second choice is for John Smith of Harvard University. User instructions 210 instruct the user of device 110 to enter in identifier entry box 205 the number corresponding to the “John Smith” for whom contact content is being sought (e.g., “1”for John Smith of State University).

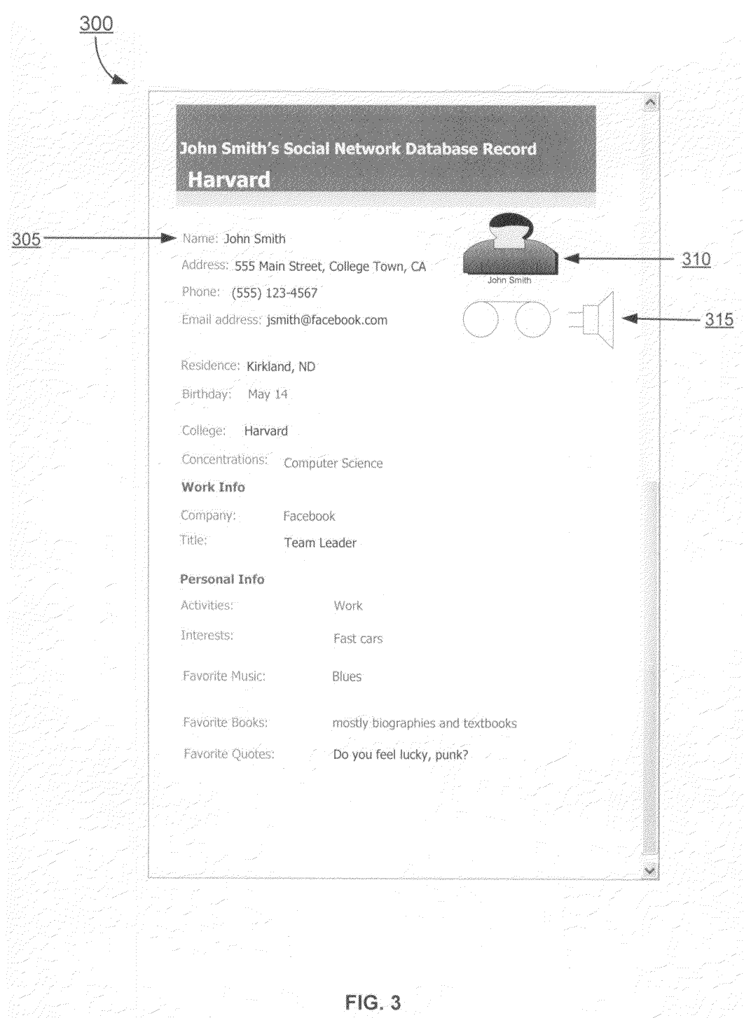

FIG. 3 shows an exemplary screenshot of a web-based social network database record 300. According to some embodiments, after the device 110 sends a query to the server 105, the query module 120 on the server 105 queries one or more web-based social network database records such as the web-based social network database record 300 that comprises part of a web-based social network database, such as the web-based social network database 165 (FIG. 1). As described herein, the social network database record 300 is the one possible source of contact content shown on a contact content screen, such as the contact content screen 400 (FIG. 4) that appears on the device display 130 (FIG. 1) of the device 110.

The social network database record 300 shown in FIG. 3 is for John Smith of Harvard University. The social network database record 300 includes John Smith's contact content 305, which includes expression content 310 and 315. The information in the social network database record 300 is entered and maintained by the particular contact who is the subject of the social network database record 300 (i.e., John Smith of Harvard University).

FIG. 4 shows a screenshot of an exemplary contact content screen. In exemplary embodiments, a contact content screen such as contact content screen 400 is displayed on the device display 130 (FIG. 1) of the device 110 (FIG. 1). The amount of information displayed on the contact content screen 400 may vary due to such factors as the size of the device display 130 and/or the ability of device specification and optimization module 135 (FIG. 1) to format the displayed information. Some or all of the information displayed on the contact content screen 400 automatically populates the contact file 160 (FIG. 1) that forms part of the device contact application 140 (FIG. 1). In exemplary embodiments, a social network database record such as social network database record 300 (FIG. 3) is one possible source of contact content appearing on a contact content screen, such as contact content screen 400.

The exemplary contact content screen 400 shown in FIG. 4 is for John Smith of Harvard University (choice “2” in FIG. 2). According to some embodiments, the contact content screen 400 includes some or all of the information contained in a social network database record, such as social network database record 300 (FIG. 3). In FIG. 4, the contact content screen 400 includes some or all of John Smith's contact content 305, which includes expression content 310 and 315.

The contact content on the contact content screen 400 automatically populates the contact file 160 on the device 110. As a result, the need to manually populate a contact file by using a keyboard to enter contact content is avoided. Additionally, typographical errors are reduced or eliminated by automatically populating the contact file 160.

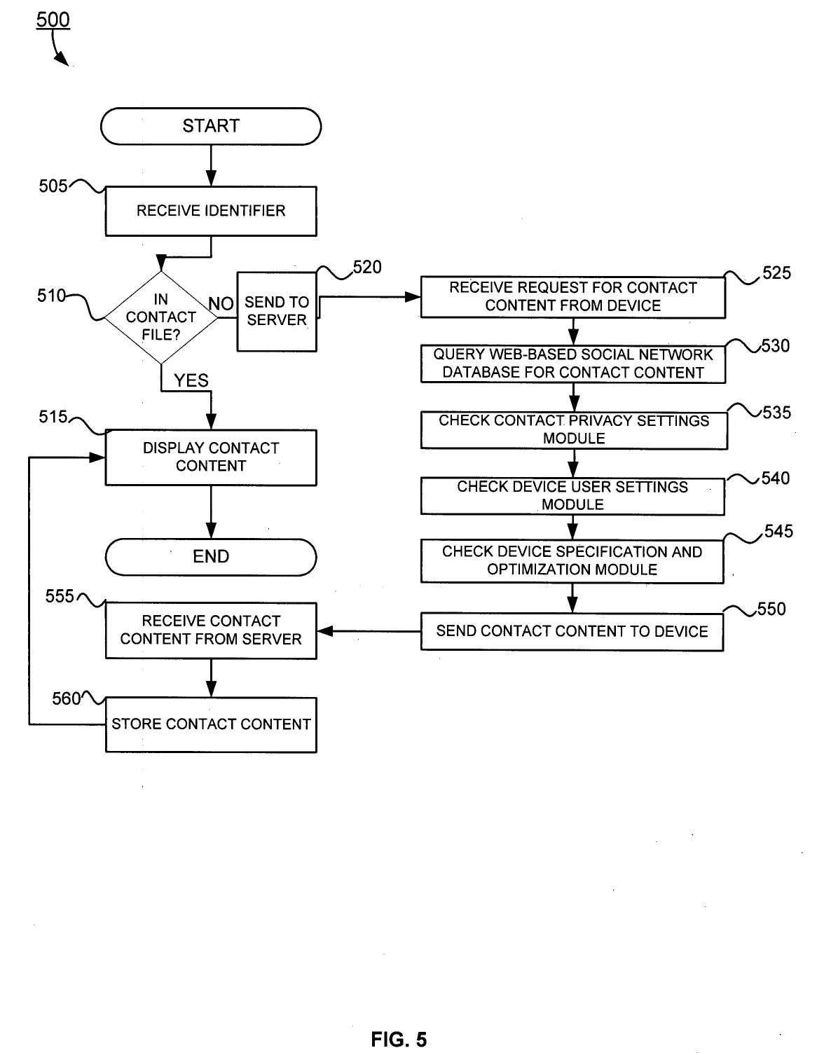

FIG. 5 shows a flow chart for an exemplary method 500 for automatically populating a contact file 160 (FIG. 1) on a device 110 (FIG. 1) with contact content from a server 105 (FIG. 1).

At step 505, device 110 receives an identifier. In exemplary embodiments, an identifier of a contact having associated contact content in the web-based social network database 165 (FIG. 1) is received by device 110 in identifier entry box 205 (FIG. 2). An identifier can be entered by a user of device 110 or device 110 can receive an identifier from a second device.

At step 510, the device 110 checks or queries contact file 160 for contact content associated with the identifier. If contact content associated with the identifier is located in the contact file 160, contact content can be displayed on the device display 130 (FIG. 1) (step 515). If contact content associated with an identifier is not located in contact file 160, device 110 will send a query to server 105 (FIG. 1) (step 520).

At step 515, if contact content associated with an identifier is located in contact file 160, the contact content will be displayed on the device display 130, which effectively ends the process. In exemplary embodiments, contact content is displayed in a format the same as or similar to that shown in contact content screen 400 (FIG. 4) as displayed on device display 130.

At step 520, if contact content associated with an identifier is not located in contact file 160, device 110 will send a query to server 105. According to various embodiments, contact content request module 150 uses an identifier to request contact content from the server 105.

At step 525, server 105 receives the request for contact content across network 125 from device 110. Network 125 may include an Internet network and/or other wireless or wired networks such as mobile device carrier networks.

At step 530, query module 120 (FIG. 1) on server 105 queries web-based social network database 165 for the contact content associated with the identifier. According to some embodiments, query module 120 can use a variety of identifiers to query web-based social network database 165 for contact content.

At step 535, server 105 checks a contact privacy settings module 155 (FIG. 1). A contact privacy settings module 155 is configured to limit querying of web-based social network database 165. Alternatively, the privacy settings module 155 can be configured to limit the contact content sent from server 105 to the device 110.

At step 540, server 105 checks a device user settings module 145 (FIG. 1). Device user settings module 145 controls such functions as when server 105 communicates with device 110. Device user settings module 145 can also be configured to direct server 105 to communicate contact content to the device 110 in response to certain changes in web-based social network database 165.

At step 545, the server checks a device specification and optimization module 135 (FIG. 1). Device specification and optimization module 135 is configured with the specifications for a wide variety of devices 110 communicating with server 105. Device specification and optimization module 135 recognizes the type of device 110 being used to communicate with the server 105 and formats contact content to accommodate the specifications of a particular device 110.

At step 550, contact content is sent from server 105 to device 110. A number of commonly known communications mechanisms can be used for server 105 to communicate with device 110 across the network 125.

At step 555, device 110 receives the contact content from the server 105.

At step 560, the contact content is stored in contact file 160. A contact file 160 is a component of the device contact application 140 on the device 110. In addition to storing contact content received from server 105, contact file 160 can store information manually entered by a user on device 110. The process then returns to step 515, where contact content associated with an identifier is displayed on device display 130, which effectively ends the process.

While various embodiments have been described above, it should be understood that they have been presented by way of example only, and not limitation. For example, any of the elements associated with automatically populating a contact file with contact content and expression content may employ any of the desired functionality set forth hereinabove. Thus, the breadth and scope of a preferred embodiment should not be limited by any of the above-described exemplary embodiments.

What is claimed is:

1. A method of automatically populating a contact file comprising:
receiving across a network a request for contact content;
querying a web-based social network database for the contact content; and
providing the contact content to a communications module for transmitting across the network to a device having a contact file configured to automatically store the contact content.

2. The method of claim 1, wherein the contact content includes updated contact content.

3. The method of claim 1, wherein the contact content includes expression content.

4. The method of claim 1, wherein the contact content includes updated expression content.

5. The method of claim 3, wherein the expression content includes audio/video data.

6. The method of claim 1, wherein the contact content includes information from a social map, a social timeline or a social network database record.

7. The method of claim 1, wherein the contact content is limited by a contact privacy settings module before transmitting to the device.

8. The method of claim 1, wherein the transmitting to the device is directed by a device user settings module.

9. The method of claim 1, wherein the request for contact content is received in the form of an identifier.

10. A server contact application comprising:
a query module configured to query a web-based social network database for contact content;
a device specification and optimization module configured to optimize the contact content to accommodate specifications of a user device; and
a device user settings module configured to store settings for the user device.

11. The server contact application of claim 10, further comprising:
a web-based social network database.

12. The server contact application of claim 10, further comprising:
a contact privacy settings module configured to limit querying of the web-based social network database.

13. The server contact application of claim 12, wherein the contact privacy settings module is alternatively configured to limit contact content before transmission to the user device.

14. A method of automatically populating a contact file comprising:
receiving into a device an identifier associated with contact content;
automatically checking a contact file on the device for the contact content;
if the contact file on the device does not contain the contact content, automatically sending the identifier to a web-based server;
automatically receiving into the device from the server the contact content associated with the identifier;
automatically storing the contact content in the contact file on the device; and
displaying some or all of the contact content on a display of the device.

15. The method of claim 14, wherein the contact content includes expression content.

16. The method of claim 14, wherein the step of receiving into a device an identifier associated with contact content further comprises receiving the identifier from a second device.

17. An apparatus for automatically populating a contact file comprising:
a device configured to receive an identifier associated with contact content;
a contact file on the device, the contact file configured to automatically store the contact content;
the device configured to display the contact content stored in the contact file;
a contact content request module on the device, the contact content request module configured to request from a server contact content for an identifier unassociated with the contact content stored in the contact file; and
the device configured to automatically receive the contact content for the identifier unassociated with the contact content stored in the contact file.

18. The apparatus of claim 17, wherein the contact content stored in the contact file or the contact content for the identifier unassociated with the contact content stored in the contact file includes expression content.

19. A system comprising:
a device configured to receive an identifier associated with contact content;
a contact file on the device configured to automatically store the contact content;
the device configured to display the contact content stored in the contact file;
a contact content request module on the device, the contact content request module configured to automatically request from a server contact content for an identifier unassociated with the contact content stored in the contact file;
the server further comprising a query module configured to query a web-based social network database for the contact content for the identifier unassociated with the contact content stored in the contact file;
a device specification and optimization module on the server configured to automatically optimize the contact content for the identifier unassociated with the contact content stored in the contact file to accommodate specifications of the device; and
a device user settings module on the server configured to store settings for sending the contact content for the identifier unassociated with the contact content stored in the contact file to the device.
